(19) United States
(12) Patent Application Publication
(10) Pub. No.: US 2026/0264000 A1
(43) Pub. Date: Sep. 10, 2026

(54) CARBON DIOXIDE SEPARATION DEVICE

(71) Applicant: HONDA MOTOR CO., LTD., Tokyo (JP)

(72) Inventor: Takuma Arai, Wako-shi (JP)

(21) Appl. No.: 19/544,070

(22) Filed: Feb. 19, 2026

(30) Foreign Application Priority Data
Mar. 5, 2025 (JP) 2025-034293

(51) Int. Cl. B01D 53/22

(52) U.S. Cl. CPC B01D 53/226; B01D 2053/221; B01D 2257/504

(57) ABSTRACT

A carbon dioxide separation device includes a first membrane separator and a second membrane separator coupled together in series, a circulation path configured to circulate a non-permeate gas not permeated by membrane separation with the second membrane separator into a raw material gas introduction line connected to the first membrane separator, flow rate adjustment part provided in the circulation path and configured to adjust the flow rate of the non-permeate gas, and effective membrane area adjustable part configured to change the effective membrane area of a separation membrane in the second membrane separator.

### CROSS-REFERENCE TO RELATED APPLICATION

Priority is claimed on Japanese Patent Application No. 2025-034293, filed March 05, 2025, the content of which is incorporated herein by reference.

### BACKGROUND OF THE INVENTION

### Field of the Invention

The present invention relates to a carbon dioxide separation device.

### Description of Related Art

For example, as a technique for separating and recovering carbon dioxide (CO₂) from natural gas containing methane (CH₄), a carbon dioxide separation device including a raw material gas introduction line configured to introduce a raw material gas containing carbon dioxide, a first membrane separator connected to an end portion of the raw material gas introduction line and configured to membrane-separate carbon dioxide from the raw material gas, a first permeate gas discharge line configured to discharge a first permeate gas permeated by membrane separation with the first membrane separator, a first non-permeate gas discharge line configured to discharge a first non-permeate gas not permeated by membrane separation with the first membrane separator, a second membrane separator provided downstream of the first membrane separator and configured to membrane-separate carbon dioxide from the first non-permeate gas, a second permeate gas discharge line configured to discharge a second permeate gas permeated by membrane separation with the second membrane separator, and a second permeate gas returning line branched from a part of the second permeate gas discharge line and configured to return the second permeate gas to the raw material gas or the first non-permeate gas is known (refer to, for example, Japanese Unexamined Patent Application, First Publication No. 2016-93767).

### SUMMARY OF THE INVENTION

As the above-described carbon dioxide separation device, a system configured to circulate carbon dioxide in multiple stages is known. In this system, how much a circulation flow is circulated has a significant influence on the separation (recovery) performance of carbon dioxide. Normally, the circulation flow and the like are determined as design specifications depending on the area ratio of a carbon dioxide separation membrane; however, when an attempt is made to finely adjust the circulation flow rate of carbon dioxide at the time of actually operating the carbon dioxide separation device, the use of a vacuum pump that is provided in the carbon dioxide separation device is the only way to finely adjust the circulation flow rate. However, since the range of the circulation flow rate that can be adjusted with the vacuum pump is narrow, when an attempt is made to significantly change the circulation flow rate, a transmembrane pressure that is applied to the carbon dioxide membrane changes too much, and the membrane separation performance of the carbon dioxide separation membrane is significantly impaired.

An aspect of the present invention provides a carbon dioxide separation device capable of adjusting the circulation flow rate of carbon dioxide without impairing the membrane separation performance of a carbon dioxide separation membrane in the case of circulating carbon dioxide in multiple stages. The aspect of the present invention contributes to energy efficiency improvement.

The present invention has the following aspects.

1 A carbon dioxide separation device including:

at least two membrane separators coupled together in series;

a circulation path configured to circulate a non-permeate gas not permeated by membrane separation with, among the at least two membrane separators, a downstream membrane separator into a raw material gas introduction line connected to, among the at least two membrane separators, an upstream membrane separator;

flow rate adjustment part provided in the circulation path and configured to adjust a flow rate of the non-permeate gas; and

effective membrane area adjustable part configured to change an effective membrane area of a separation membrane in the downstream membrane separator.

According to the aspect, the circulation flow rate of carbon dioxide can be controlled without being adjusted with a vacuum pump. In addition, in the case of controlling the circulation flow rate of carbon dioxide with the flow rate adjustment part, the inlet pressure (high pressure side) of a circulation flow in the upstream membrane separator increases, consequently, the transmembrane pressure between the high-pressure side and low-pressure side of the carbon dioxide separation membrane becomes large, and the carbon dioxide separation performance improves. In addition, the inlet pressure in the downstream membrane separator can be adjusted by controlling the effective membrane area of the separation membrane in the downstream membrane separator.

2 The carbon dioxide separation device according to [1], in which the effective membrane area adjustable part includes a main membrane separator and a preliminary membrane separator coupled with the main membrane separator in series.

According to the aspect, it is possible to adjust the circulation flow rate of carbon dioxide without impairing the membrane separation performance of the carbon dioxide separation membrane in the case of circulating carbon dioxide in multiple stages.

3 The carbon dioxide separation device according to [1], in which the effective membrane area adjustable part includes a shielding mechanism configured to adjust an exposed area of the separation membrane in the membrane separator.

According to the aspect, it is possible to adjust the circulation flow rate of carbon dioxide without impairing the membrane separation performance of the carbon dioxide separation membrane in the case of circulating carbon dioxide in multiple stages

4 The carbon dioxide separation device according to [1], in which in a case where the flow rate of the non-permeate gas that flows in the circulation path is higher than a target value, the flow rate of the non-permeate gas is decreased with the flow rate adjustment part, and

in a case where a pressure of the non-permeate gas is a predetermined value or higher at an introduction side of the separation membrane in the downstream membrane separator, the effective membrane area of the separation membrane in the downstream membrane separator is increased with the flow rate adjustment part.

According to the aspect, the inlet pressure (high pressure side) of the circulation flow in the upstream membrane separator increases, consequently, the transmembrane pressure between the high-pressure side and low-pressure side of the carbon dioxide separation membrane becomes large, and the carbon dioxide separation performance improves. In addition, in a case where the non-permeate gas pressure in the downstream membrane separator is a predetermined value or higher, it is possible to curb the inlet pressure in the downstream membrane separator by increasing the effective membrane area of the downstream separation membrane.

5 The carbon dioxide separation device according to [1], in which in a case where the flow rate of the non-permeate gas that flows in the circulation path is lower than a target value, the effective membrane area of the separation membrane in the downstream membrane separator is decreased with the flow rate adjustment part.

According to the aspect, the inlet pressure (high pressure side) of the circulation flow in the upstream membrane separator increases, consequently, the transmembrane pressure between the high-pressure side and low-pressure side of the carbon dioxide separation membrane becomes large, and the carbon dioxide separation performance improves. In addition, the effective membrane area of the separation membrane in the downstream membrane separator is decreased to increase the inlet pressure of the downstream membrane separator, whereby the carbon dioxide separation performance of the downstream membrane separator improves.

According to the aspects of the present invention, a carbon dioxide separation device capable of adjusting the circulation flow rate of carbon dioxide without impairing the membrane separation performance of the carbon dioxide separation membrane in the case of circulating carbon dioxide in multiple stages is provided.

### BRIEF DESCRIPTION OF THE DRAWINGS

FIG. 1 is a schematic view illustrating a carbon dioxide separation device of a first embodiment of the present invention.

FIG. 2 is a flowchart of a carbon dioxide separation method in which the carbon dioxide separation device of the first embodiment of the present invention is used.

FIG. 3 is a schematic view illustrating a carbon dioxide separation device of a second embodiment of the present invention.

### DETAILED DESCRIPTION OF THE INVENTION

Hereinafter, embodiments of the present invention will be described.

### Carbon dioxide separation device

### First embodiment

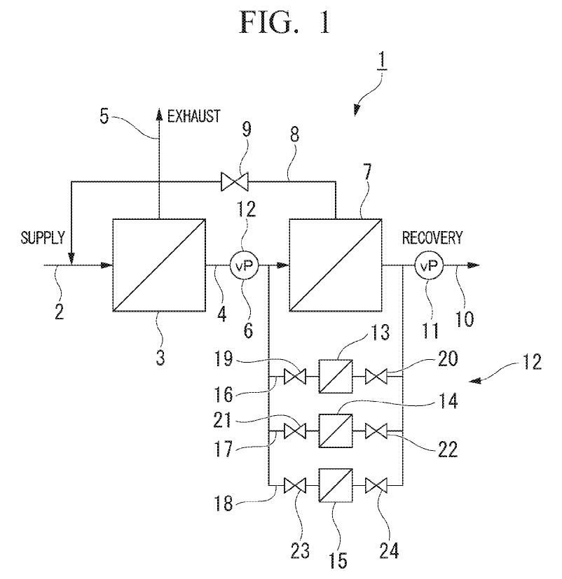

FIG. 1 is a schematic view illustrating a carbon dioxide separation device of the present embodiment.

As illustrated in FIG. 1, a carbon dioxide separation device 1 of the present embodiment includes a first raw material gas introduction line 2, a first membrane separator 3, a first permeate gas discharge line 4, a first non-permeate gas discharge line 5, a first vacuum pump 6, a second membrane separator 7, a circulation path 8, flow rate adjustment part 9, a second permeate gas discharge line 10, a second vacuum pump 11, and effective membrane area adjustable part 12. The first membrane separator 3 and the second membrane separator 7 are coupled together in series.

The first raw material gas introduction line 2 is intended to introduce a raw material gas containing carbon dioxide into the first membrane separator 3.

The first membrane separator 3 is connected to the end portion of the first raw material gas introduction line 2 and is intended to introduce the raw material gas and membrane-separate the raw material gas. In addition, the first membrane separator 3 is connected to the first permeate gas discharge line 4 and is connected to the second membrane separator 7 through the first permeate gas discharge line 4. As the first membrane separator 3, a carbon dioxide separator including an ordinary carbon dioxide separation membrane can be used.

The first permeate gas discharge line 4 is connected to the first membrane separator 3 and is intended to discharge a first permeate gas permeated by membrane separation with the first membrane separator 3 from the first membrane separator 3.

The first non-permeate gas discharge line 5 is connected to the first membrane separator 3 and is intended to discharge a first non-permeate gas not permeated by membrane separation with the first membrane separator 3.

The first vacuum pump 6 is provided in the middle of the first permeate gas discharge line 4 and is intended to supply the first permeate gas to the second membrane separator 7.

The second membrane separator 7 is provided downstream of the first membrane separator 3 and is connected to the first permeate gas discharge line 4. In addition, the second membrane separator 7 is intended to membrane-separate the first permeate gas supplied from the first membrane separator 3. As the second membrane separator 7, a carbon dioxide separator including an ordinary carbon dioxide separation membrane can be used.

The circulation path 8 is intended to circulate a non-permeate gas not permeated by membrane separation with the second membrane separator 7 into the first raw material gas introduction line 2 connected to the first membrane separator 3.

The flow rate adjustment part 9 is provided in the middle of the circulation path 8 and is intended to adjust the flow rate of the non-permeate gas. As the flow rate adjustment part 9, a solenoid valve or the like can be used.

The second permeate gas discharge line 10 is connected to the second membrane separator 7 and is intended to discharge a second permeate gas permeated by membrane separation with the second membrane separator 7 from the second membrane separator 7.

The second vacuum pump 11 is provided in the middle of the second permeate gas discharge line 10 and is intended to discharge the second permeate gas from the second membrane separator 7.

The effective membrane area adjustable part 12 is intended to change the effective membrane area of the separation membrane in the second membrane separator 7. The effective membrane area adjustable part 12 specifically includes the main membrane separator (second membrane separator) 7 and preliminary membrane separators 13, 14, and 15 coupled to the main membrane separator 7 in parallel.

The preliminary membrane separator 13 is connected to the first permeate gas discharge line 4 and the second permeate gas discharge line 10 through a gas line 16 and is coupled to the main membrane separator 7 in parallel. Vacuum pumps 19 and 20 are provided upstream and downstream of the preliminary membrane separator 13 in the middle of the gas line 16. The preliminary membrane separator 14 is connected to the first permeate gas discharge line 4 and the second permeate gas discharge line 10 through a gas line 17 and is coupled to the main membrane separator 7 in parallel. Vacuum pumps 21 and 22 are provided upstream and downstream of the preliminary membrane separator 14 in the middle of the gas line 17. The preliminary membrane separator 15 is connected to the first permeate gas discharge line 4 and the second permeate gas discharge line 10 through a gas line 18 and is coupled to the main membrane separator 7 in parallel. Vacuum pumps 23 and 24 are provided upstream and downstream of the preliminary membrane separator 15 in the middle of the gas line 18.

A control logic of the carbon dioxide separation device of the present embodiment will be described.

In a case where the flow rate of the non-permeate gas that flows in the circulation path 8 is higher than a target value, the flow rate of the non-permeate gas is decreased with the flow rate adjustment part 9, and in a case where the pressure of the non-permeate gas is a predetermined value or higher on a gas introduction side of the separation membrane in the second membrane separator 7, the effective membrane area of the separation membrane in the second membrane separator 7 is increased with the flow rate adjustment part 9. As a result, the inlet pressure (high pressure side) of the circulation flow in the first membrane separator 3 on the upstream side increases, consequently, the transmembrane pressure between the high-pressure side and low- pressure side of the carbon dioxide separation membrane becomes large, and the carbon dioxide separation performance improves.

In a case where the flow rate of the non-permeate gas that flows in the circulation path 8 is lower than the target value, the effective membrane area of the separation membrane in the second membrane separator 7 is decreased with the flow rate adjustment part 9. As a result, the inlet pressure (high pressure side) of the circulation flow in the first membrane separator 3 on the upstream side increases, consequently, the transmembrane pressure between the high-pressure side and low-pressure side of the carbon dioxide separation membrane becomes large, and the carbon dioxide separation performance improves.

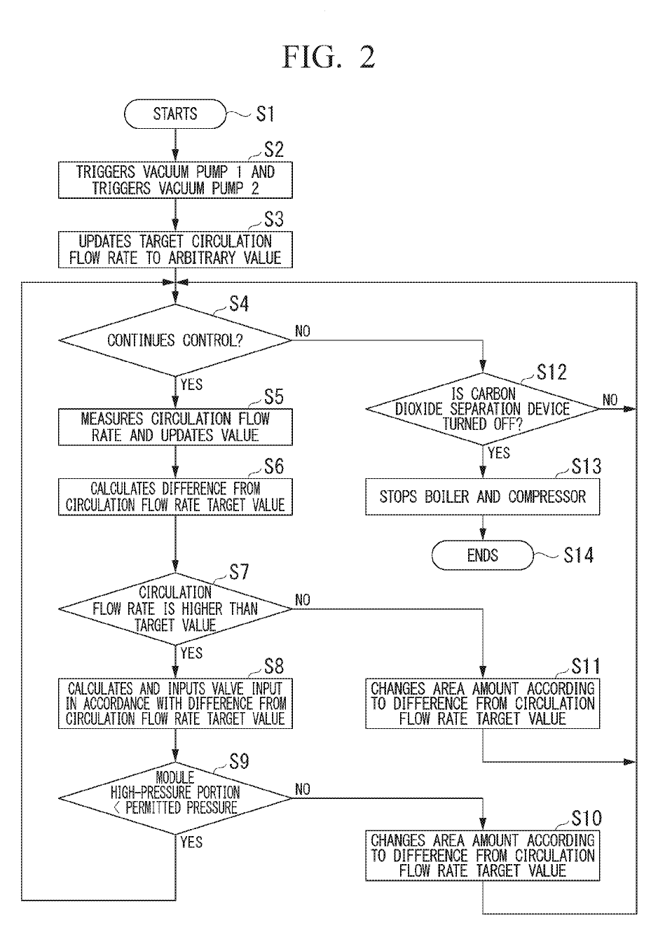

FIG. 2 is a flowchart of a carbon dioxide separation method in which the carbon dioxide separation device of the present embodiment is used.

The carbon dioxide separation device 1 is turned on to operate the carbon dioxide separation device 1 (step: S1). Then, the first vacuum pump 6 and the second vacuum pump 11 are triggered (step: S2).

Next, the target value of the flow rate of the non-permeate gas that flows in the circulation path 8 is set to an arbitrary value (step: S3).

Whether or not to continue the control of the flow rate of the non-permeate gas that flows in the circulation path 8 is confirmed (step: S4). In the case of continuing the control of the flow rate of the non-permeate gas that flows in the circulation path 8, the flow rate (circulation flow rate) of the non-permeate gas that flows in the circulation path 8 is measured, and the target value of the flow rate of the non-permeate gas that flows in the circulation path 8 is updated (step: S5).

Next, a difference between the measurement value of the flow rate of the non-permeate gas that flows in the circulation path 8 and the target value of the flow rate of the non-permeate gas that flows in the circulation path 8 is calculated (step: S6).

Whether or not the flow rate of the non-permeate gas that flows in the circulation path 8 is higher than a target value 1 is confirmed (step: S7).

In a case where the flow rate of the non-permeate gas that flows in the circulation path 8 is higher than the target value 1, the flow rate adjustment part 9 is controlled according to the difference between the measurement value of the flow rate of the non-permeate gas that flows in the circulation path 8 and the target value of the flow rate of the non-permeate gas that flows in the circulation path 8. In detail, the opening degree of the solenoid valve is adjusted (step: S8).

Next, whether or not the pressure in a portion where the pressure has increased in the carbon dioxide separation device 1 is lower than a pressure that is permitted for the carbon dioxide separation device 1 is confirmed (step: S9).

In a case where the pressure in the portion where the pressure has increased in the carbon dioxide separation device 1 is lower than the pressure that is permitted for the carbon dioxide separation device 1, the process is returned to the step: S4.

In a case where the pressure in the portion where the pressure has increased in the carbon dioxide separation device 1 is higher than the pressure that is permitted for the carbon dioxide separation device 1, the effective membrane area of the separation membrane in the second membrane separator 7 is changed with the effective membrane area adjustable part 12 according to the difference between the measurement value of the flow rate of the non-permeate gas that flows in the circulation path 8 and the target value of the flow rate of the non-permeate gas that flows in the circulation path 8, and the process is returned to the step: S4 (step: S10).

In a case where the flow rate of the non-permeate gas that flows in the circulation path 8 is lower than the target value 1, the effective membrane area of the separation membrane in the second membrane separator 7 is changed with the effective membrane area adjustable part 12 according to the difference between the measurement value of the flow rate of the non-permeate gas that flows in the circulation path 8 and the target value of the flow rate of the non-permeate gas that flows in the circulation path 8, and the process is returned to the step: S4 (step: S11).

In the case of not continuing the control of the flow rate of the non-permeate gas that flows in the circulation path 8 in the step: S4, whether or not to turn off the carbon dioxide separation device 1 is determined (step: S12). In a case where the carbon dioxide separation device 1 is not turned off, the process is returned to the step: S4.

In a case where the carbon dioxide separation device 1 is turned off, the first vacuum pump 6 and the second vacuum pump 11 are stopped (step: S13), and the operation of the carbon dioxide separation device 1 is stopped (step: S14).

According to the carbon dioxide separation device 1 of the present embodiment, the circulation flow rate of carbon dioxide can be controlled without being adjusted with the first vacuum pump 6 and the second vacuum pump 11. In addition, in the case of controlling the circulation flow rate of carbon dioxide with the flow rate adjustment part 9, the inlet pressure (high pressure side) in the first membrane separator 3 increases, consequently, the transmembrane pressure between the high-pressure side and low-pressure side of the carbon dioxide separation membrane becomes large, and the carbon dioxide separation performance improves.

### Second embodiment

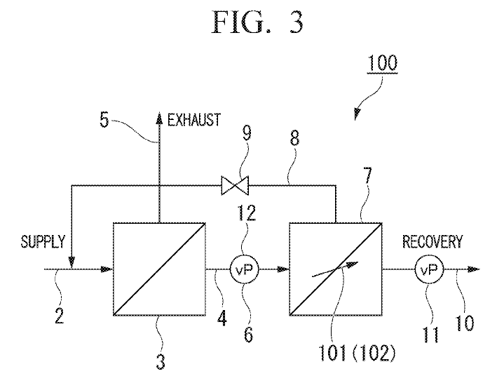

FIG. 3 is a schematic view illustrating a carbon dioxide separation device of the present embodiment. In FIG. 3, the same configuration as the configuration illustrated in FIG. 1 will be given the same reference sign and will not be described again.

As illustrated in FIG. 3, a carbon dioxide separation device 100 of the present embodiment includes effective membrane area adjustable part 101 instead of the effective membrane area adjustable part 12 in the above-described carbon dioxide separation device 1.

The effective membrane area adjustable part 101 includes a shielding mechanism 102 configured to adjust the exposed area of the separation membrane in the second membrane separator 7.

The shielding mechanism 102 is intended to cover the surface of the separation membrane in the second membrane separator 7 and to adjust the exposed area of the separation membrane by controlling the area to cover of the surface of the separation membrane.

According to the carbon dioxide separation device 100 of the present embodiment, the circulation flow rate of carbon dioxide can be controlled without being adjusted with the first vacuum pump 6 and the second vacuum pump 11. In addition, in the case of controlling the circulation flow rate of carbon dioxide with the flow rate adjustment part 9, the inlet pressure (high pressure side) in the first membrane separator 3 increases, consequently, the transmembrane pressure between the high-pressure side and low-pressure side of the carbon dioxide separation membrane becomes large, and the carbon dioxide separation performance improves.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A carbon dioxide separation device comprising:
at least two membrane separators coupled together in series;
a circulation path configured to circulate a non-permeate gas not permeated by membrane separation with, among the at least two membrane separators, a downstream membrane separator into a raw material gas introduction line connected to, among the at least two membrane separators, an upstream membrane separator;
flow rate adjustment part provided in the circulation path and configured to adjust a flow rate of the non-permeate gas; and
effective membrane area adjustable part configured to change an effective membrane area of a separation membrane in the downstream membrane separator.

2. The carbon dioxide separation device according to claim 1,
wherein the effective membrane area adjustable part includes a main membrane separator and a preliminary membrane separator coupled with the main membrane separator in series.

3. The carbon dioxide separation device according to claim 1, wherein the effective membrane area adjustable part includes a shielding mechanism configured to adjust an exposed area of the separation membrane in the membrane separator.

4. The carbon dioxide separation device according to claim 1, wherein in a case where the flow rate of the non-permeate gas that flows in the circulation path is higher than a target value, the flow rate of the non-permeate gas is decreased with the flow rate adjustment part, and
in a case where a pressure of the non-permeate gas is a predetermined value or higher at an introduction side of the separation membrane in the downstream membrane separator, the effective membrane area of the separation membrane in the downstream membrane separator is increased with the flow rate adjustment part.

5. The carbon dioxide separation device according to claim 1, wherein in a case where the flow rate of the non-permeate gas that flows in the circulation path is lower than a target value, the effective membrane area of the separation membrane in the downstream membrane separator is decreased with the flow rate adjustment part.
